(19) United States
(12) Patent Application Publication
(10) Pub. No.: US 2004/0012360 A1
(43) Pub. Date: Jan. 22, 2004

(54) Remote-control utility equipment mounting apparatus

(76) Inventor: Siltex Peter Yuen, San Jose, CA (US)

Correspondence Address: Siltex Peter Yuen, 2765 Henessy Drive, San Jose, CA, 95148, US

(21) Appl. No.: 10/201,092

(22) Filed: Jul. 22, 2002

(51) Int. Cl. G05B 11/01

(52) U.S. Cl. 318/560; 318/16; 318/17

(57) ABSTRACT

A remote-control portable utility equipment mounting apparatus system especially for illumination system. It provides the user the ability to control the direction of the utility equipment such as utility light from a distance away. The remote-control portable utility equipment mounting apparatus provides polar rotational movement both horizontally and vertically. The rotational movement is controlled by remote controlling device as the input instructional device by the user. This remote controller can be wireless remote controller or non-wireless remote controller. After the portable utility equipment mounting apparatus receives the signals, it generates electrical functions to drive the designated motors to move the equipment mounting stage subassembly direction to the preferred direction. Power saving, fine-tuning and variable speed control are some of the basic features of this utility equipment mounting stage. Both remote controller and wireless remote controller are equipped with electronic signal connector for receiving inputs from external equipment like computers and programmable controllers. As a result, this apparatus is suitable to be used for mounting of different utility equipment such as antennas, surveillance equipment etc. This apparatus is equipped with magnetic latch for simple and easy vehicle roof mounting. It is weather resistance and good for outdoor application. Furthermore, with the present of the mechanical seal between the stator subassembly and the rotor subassembly, foreign matters cannot enter into the inside chamber of the system and the contaminants generated by the motors and gears cannot get to the outside ambient either. This feature promotes this utility equipment mounting apparatus to be cleanroom compatible.

### FIELD OF INVENTION

The present invention relates generally to portable utility equipment mounting equipment, and more particularly to wirelessly remote control vehicle roof utility illumination mounting device. This present invention is rain resistance.

### BACKGROUND OF THE INVENTION

Minivans and Sport Utility Vehicles are very popular these days. Families use these vehicles to go camping and sometimes move belongings from place to place after dark. However, the utility lights available are awkward to use. It is ideal if the driver can search around the surroundings when driving in a dark off road area. It will be perfect if there is an utility light that is portable with pan and tilt functions, and easy to be installed to the roof of the vehicles; especially if it has a wirelessly remote-controllable capability with weather protection feature.

Thus there is a need for an utility illumination system to provide the driver to control the illuminating direction from a remote distance. This utility illumination system should simulate a person's hand such that it can rotate back and forth horizontally and tilt up and down vertically. This will allow the user to illuminate the area or search around the surrounding.

Further, there is also a need for a wirelessly controllable utility stand apparatus with pan and tilt functions for mounting other available equipment like antennas and surveillance devices. In addition, this device has to be low cost, portable, easy to operate, light weight and rugged.

The present invention provides such an utility equipment mounting system.

### CROSS REFERENCE TO RELATED APPLICATIONS

Field of Search

Intern'l Class: B60 Q 1/00; H04Q 1/00; H03K 17/00; H02K 37/00, 10

US Class 362/84, 227, 257; 367/117; 388/825; 343/882, 715, 766; 42/94, 111

U.S. Patent Documents

| | | | |
|---|---|---|---|
| 5769526A | Aug. 16, 1995 | Shaffer | 362/80 |

This patent is a manually adjustable utility light with a

| mechanical clamp; and the invention has nothing to do with the | | | |
|---|---|---|---|
| wireless technology. | | | |
| 5266738 | Nov. 30, 1993 | MacVoy | 174/45R |

This patent is not remote control system.

| | | | |
|---|---|---|---|
| 5335149 | Aug. 2, 1994 | Evans | 362/477 |

This patent is not remote control system.

| | | | |
|---|---|---|---|
| 5479181 | Dec. 26, 1995 | Simpson | 343/882 |

This patent is not remote control system.

| | | | |
|---|---|---|---|
| 5410327 | Apr. 25, 1995 | Shakum | 343/765 |

This patent is not remote control system.

| | | | |
|---|---|---|---|
| 5402135 | Mar. 28, 1995 | DeMarre | 343/715 |

This patent is not remote control system.

| | | | |
|---|---|---|---|
| 5945945 | Aug. 31, 1999 | Wagner | 342/359 |

This is satellite dish antenna tracking method with

| feedback from satellite. | | | |
|---|---|---|---|
| 6222504 | Apr. 24, 2001 | Oby | 343/892 |

This patent is not remote control system.

| | | | |
|---|---|---|---|
| 6195060 | Feb. 27, 2001 | Spano | 343/766 |

This patent is with different mechanisms and no tilt

| function and not wireless remote-control. | | | |
|---|---|---|---|
| 5491919 | Feb. 20, 1996 | Rather | 42/94 |

U.S. Patent Documents 5769526A Aug. 16, 1995 Shaffer 362/80 This patent is a manually adjustable utility light with a mechanical clamp; and the invention has nothing to do with the wireless technology. 5266738 Nov30, 1993 MacVoy 174/45R This patent is not remote control system. 5335149 Aug2, 1994 Evans 362/477 This patent is not remote control system. 5479181 Dec. 26, 1995 Simpson 343/882 This patent is not remote control system. 5410327 Apr. 25, 1995 Shakum 343/765 This patent is not remote control system. 5402135 March28, 1995 DeMarre 343/715 This patent is not remote control system. 5945945 Aug31, 1999 Wagner 342/359 This is satellite dish antenna tracking method with feedback from satellite. 6222504 Apr. 24, 2001 Oby 343/892 This patent is not remote control system. 6195060 Feb. 27, 2001 Spano 343/766 This patent is with different mechanisms and no tilt function and not wireless remote-control. 5491919 Feb. 20, 1996 Rather 42/94

### SUMMARY OF THE INVENTION

A remote control utility equipment mounting device with pan and tilt functions system for mounting of vehicle utility equipment is portable, light weight and rain resistance. It includes a main system, a device controller and a wireless device controller.

The device controller includes electronic components and program, which receives input signals, generates signal functions and transmits the signal functions to the main system via electrical or optical cable.

The wireless device controller, which is setup to work with the above device controller, includes electronic components and program. It receives input signals, generates signal functions and transmits the signal functions to the main system wirelessly.

The main system includes mechanical hardware to provide horizontal polar movement and vertical polar movement and a mounting stage. It also includes electronic components and firmware program, which receives signal functions from the wireless device controller wirelessly or the device controller; and provides electrical driving functions to control the mechanical hardware into precision fine rotational movement of the main system. The main system has power saving features.

This device is equipped with magnetic latch hold down feature for easy installation on to the sheet metal roof of a vehicle.

This device is suitable for providing mounting means for general equipment such as utility lights, antennas and surveillance equipment, which require directional control.

Other features and advantages of the invention will appear from the following description in which the preferred embodiments have been set forth in detail, in conjunction with the accompanying drawings.

### BRIEF DESCRIPTION OF THE DRAWINGS

FIG. 1 is the front plan view of the remote-control utility equipment mounting system includes a wireless handheld device controller, a main system and a remote controller.

FIG. 2 is the cross section view of the main system assembly taken along the line 1-1 of FIG. 1. It depicts a portion of the utility equipment stage subassembly, a portion of the vertical polar motion mechanical driver system, a portion of the rotor core subassembly, a portion of the PCBA, the battery, a portion of the horizontal polar motion mechanical driver system, a portion of the base subassembly, a portion of the electrical signal feed through connection from the control cable to the utility equipment stage subassembly, a portion of the magnetic latch hold down mechanism and the seal according to the present invention.

FIG. 3 is the isolated view of FIG. 2 of the vertical polar motion mechanical driver system depicting a portion of the utility equipment stage subassembly, a portion of the pivot shaft, a portion of the vertical motion worm gear, the worm, a portion of the rotor core, a portion of the bearing, washers, preload spring, torque coupler, the motor, limit switches and mounting screw according to the present invention.

FIG. 4 is the exposed front view of the horizontal polar motion mechanical driver system depicting a portion of the rotor core, a portion of the stator base subassembly, the motor, torque coupler, the bearing, the washers, preload spring, the worm, the worm gear and a portion of the pivot shaft according to the present invention.

FIG. 5 is the top plan view taken along 2-2 of FIG. 4 of the horizontal polar motion mechanical driver system.

FIG. 6 is the exposed view of Detail 1 of FIG. 2 depicting a portion of the top cover, a portion of the base subassembly, a portion of the mechanical seal, portions of the rotor core, a portion of the contact retainer, a portion of the conductor wire, spring loaded conductor pin, conductor pads, conductor leads, wires, a portion of the control cable, encapsulation and a portion of the cushion footpad according to the present invention.

FIG. 7 is the exposed view of Detail 2 of FIG. 2 depicting a portion of the top cover, a portion of the stator base subassembly, a portion of the mechanical seal, portions of the magnets, a portion of the magnetic flux retainer and a portion of the cushion footpad according to the present invention.

FIG. 8 is the bottom plan view of the main system depicting the magnets, mounting holes, guide hole, control cable, encapsulation and mounting screws according to the present invention.

FIG. 9 is the front plan view of the main system with an utility lamp mounted on it. It depicts the main system, an utility lamp, portion of the mounting flange and screws according to the present invention.

### DETAILED DESCRIPTION OF THE PREFERRED EMBODIMENT

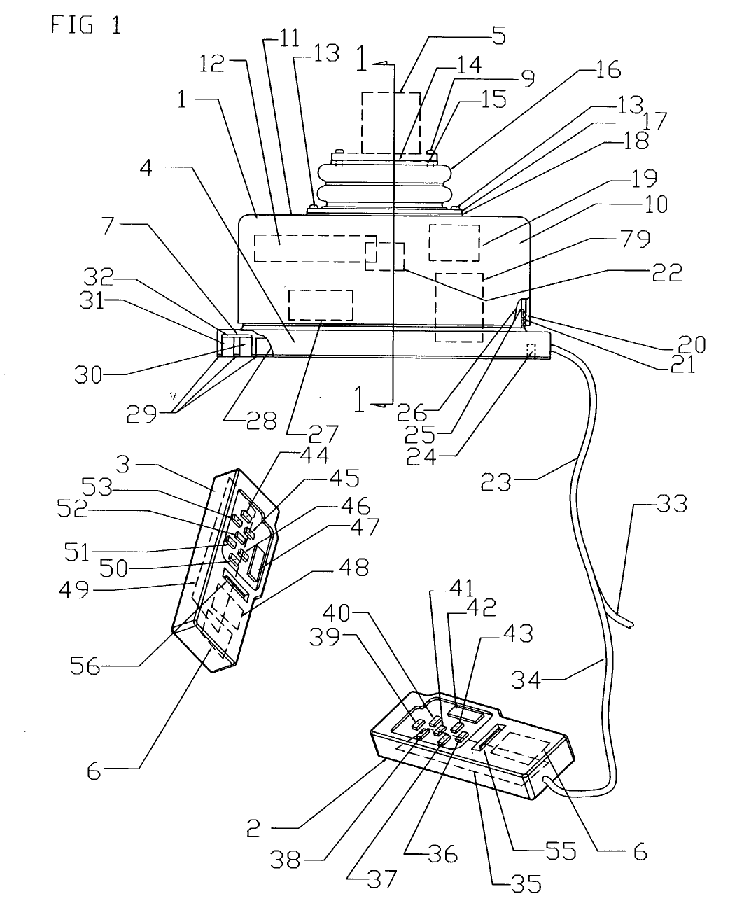

FIG. 1 is the front view of the overall system of the remote-control utility equipment mounting apparatus, which includes a wireless handheld device controller 3, a main system 1 and a remote controller 2, according to the present invention.

The stator base 4 is the stationary reference of the main system 1. The rotor subassembly 10 rotates relatively to stator base 4 through the rotational axis. The horizontal rotational motion is driven by the horizontal motion motor-driver-subassembly 27, which is supported by the rotor subassembly 10 and has the capability to rotate in either clockwise or counterclockwise direction infinitely which is defined as without any angular limitation.

The vertical rotational tilt motion is driven by the vertical tilt motion motor-driver-subassembly 19, which is supported by the rotor subassembly 10. The mounting stage 14 is supported by the vertical tilt motion motor-driver-subassembly 19. The utility equipment 5 is mounted to mounting stage 14 by fastener 9 securing to mounting hole 15. The fastener 9 can be screw, rivet, or any other fastener that can facilitate the assembly function. As a result the utility equipment 5 can tilt and rotate relatively to the stator base 4.

Both the vertical tilt motion motor-driver-subassembly 19 and the horizontal motion motor-driver-subassembly 27 are connected electrically to the main PCBA 12 and are all mounted to the rotor subassembly 10.

The elastic boot cover 16 is secured to the top cover 11 of the rotor subassembly 10 by fastener 13. The bracket 17 clamps the flange 18 of the elastic boot cover 16 evenly to the rotor top cover 11 and provides watertight seal against foreign matters. At least one fastener 13, which can be screw, rivet, or any other fastener that can facilitate the assembly function, is used to facilitate the assembly. Foreign matters include dust, rain, fluid and contamination.

The mechanical seal 21, which is mounted between the vertical wall 25 of the stator base 4 and the internal wall 20 of the rotor top cover 11 (shown at cutout 26), provides a seal against foreign matters.

The magnet 30 and magnet 31 are magnetically linked together by the flux retainer 32. The other open ends of the magnet 30 and magnet 31 are to be used to hold down the stator base 4 to a magnetic permeable surface as the magnetic latch 7. The flux retainer 32 minimizes the magnetic flux leakage from the ends of the magnets.

The cushion footpad 29, which is adhered to the bottom of the stator base 4 provides a gasket layer between the bottom surface of the stator base 4 and the surface which the stator base 4 is mounted on. It also provides a cushion to withstand any minor irregularity of the resting surfaces. Mounting hole 24 is provided for fastener mounting of the stator base 4 permanently to a surface.

The signal cable 34 of the remote controller 2 merges with the power supply cable 33 and becomes the control cable 23. This control cable 23 is connected via the spring loaded contact mechanism 79 to the main PCBA 12 of the main unit 1. The switches 36, 37, 38, 39, 40, 41, 42 and 43 are connected to the PCBA 35, which consists of electronic components, programmable components and programs. As any one of these switches is activated, electrical signals will be sent to the PCBA 35, which in turn will generate an encoded signal 6 and then send this encoded signal 6 to the main PCBA 12 of the main unit 1 via the control cable 23. The PCBA 12 will then decode the signal 6 and generate the correlated electrical functions to drive the designated mechanism.

The electronic signal connector 55 is connected to the PCBA 35. It provides connections for external equipment such as computer to provide input signals to the PCBA 35 directly. Then PCBA 35 will generate an encoded signal 6 and then send this encoded signal 6 to the main PCBA 12 of the main unit 1 via the control cable 23. The PCBA 12 will then decode the signal 6 and generate the correlated electrical functions to drive the designated mechanism.

The wireless remote controller 3 includes switches 44, 45, 46, 47, 50, 51, 52 and 53, which are connected to PCBA 49. PCBA 49, which consists of electronic components, programmable components and programs, will detect input signals from the above switches; then generates corresponding encoded signal 48, which can be radio frequency signal or IR (infrared) signal, and then emits the signal 48 out wirelessly. The main PCBA 12 is also equipped with signal receiver and decoder for either radio frequency signal or IR (infrared) signal matching with PCBA 49 respectively. The main PCBA 12, which consists of electronic components, programmable components and programs, will detect and decode the signal 48 and then generate the electronic driving functions to drive the designated mechanism.

The electronic signal connector 56 is connected to the PCBA 49. It provides connections for external equipment such as computer to provide input signals to the PCBA 49 directly. Then the PCBA 49 will generate corresponding encoded signal 48, which can be radio frequency signal or IR (infrared) signal, and then emits the signal 48 out wirelessly. The main PCBA 12 is also equipped with signal receiver and decoder for either radio frequency signal or IR (infrared) signal matching with PCBA 49 respectively. The main PCBA 12, which consists of electronic components, programmable components and programs, will detect and decode the signal 48 and then generate the electronic driving functions to drive the designated mechanism.

The switches of the wireless remote controller 3 are correlated to the switches of the remote controller 2 as the following table:

Switch 44 correlated to switch 39 to rotate the mounting stage 14 clockwise

Switch 45 correlated to switch 40 to jog the mounting stage 14 clockwise

Switch 46 correlated to switch 43 to rotate the mounting stage 14 counterclockwise

Switch 47 correlated to switch 42 to jog the mounting stage 14 counterclockwise

Switch 50 correlated to switch 36 to tilt the mounting stage 14 upward

Switch 51 correlated to switch 37 to tilt the mounting stage 14 downward

Switch 52 correlated to switch 41 and is dedicated for special function signal 22

Switch 53 correlated to switch 38 and is dedicated for special function signal 22

In operation, when either switch 44 or switch 39 is activated, either signal 6 or signal 48 will be generated and sent to PCBA 12, which in turn will generate the corresponding electrical function to drive the mounting stage 14 to rotate clockwise. By the same token, all the switches of the remote controller 2 can perform the same controlling functions as the switches of the wireless remote controller 3. Both remote controller 2 and wireless remote controller 3 are independent controlling units and either controller can function with or without the other controller.

In practice, it is user's choice to determine which particular switch of the remote controller 2 is to be correlated to which particular switch of the wireless remote controller 3 and for controlling what particular function. In the same token, the special function signal 22 is to be determined by the user. Eight switches are shown in each controller; however, it is user's decision to determine the exact number of switches to be used for motion control and special function signal 22.

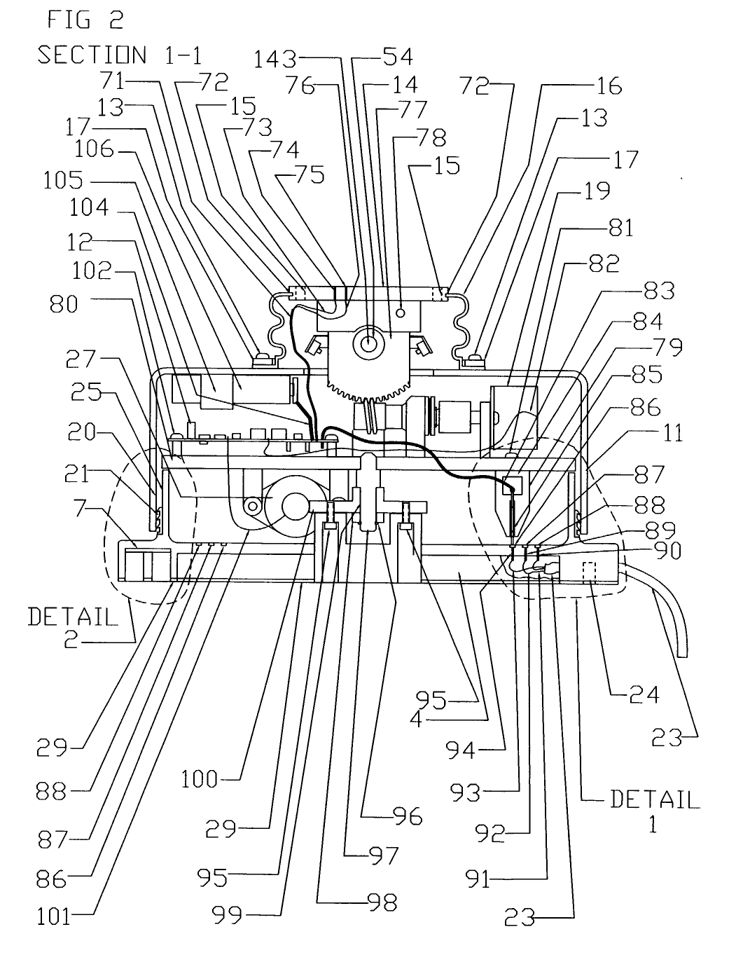

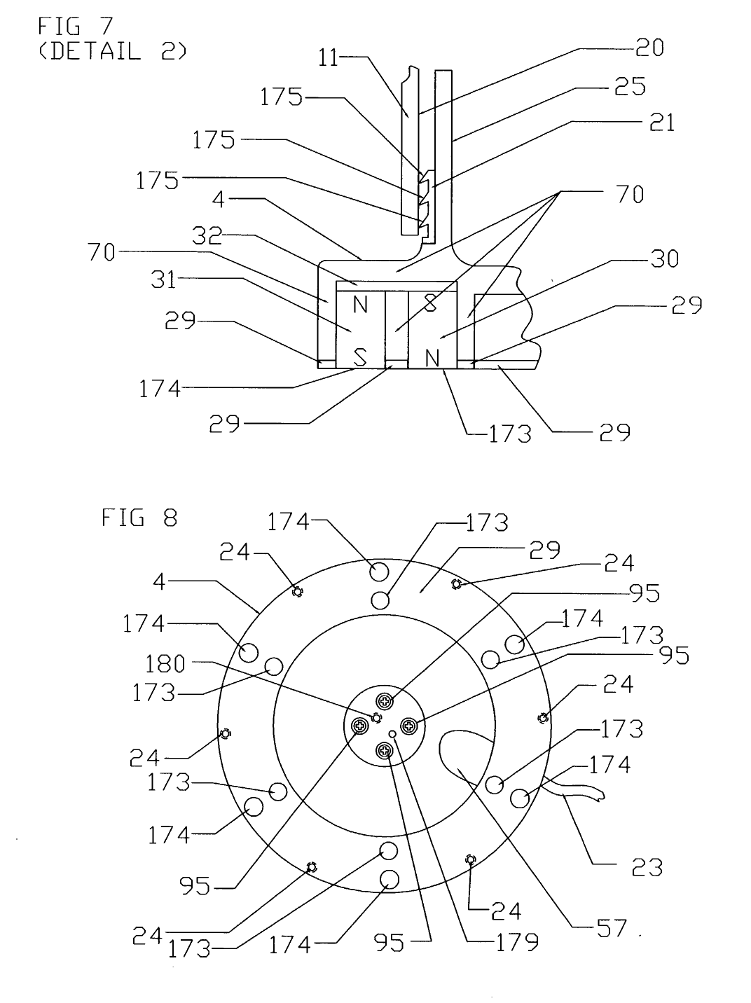

FIG. 2 is the cross section view of FIG. 1 taken along 1-1 of the main system 1, according to present invention. The stator base 4 is the base support of the complete system. The bottom layer of the stator base 4 is the cushion footpad 29 which is made of elastic material like natural rubber and silicon rubber base material. The surface of this cushion footpad 29 is textured for increased friction when the main unit 1 is resting freely on a surface. The main unit 1 can be secured by using the magnetic latch 7 to adhere to a magnetic permeable surface by magnetic force. This provides an easy process of installing and uninstalling of the main unit 1. The magnetic latch 7 system is exposed (Detail 2) in FIG. 7. At least one set of magnetic latch 7 system is used to facilitate the assembly. The main unit 1 can also be mounted permanently by fastener fastening to mounting hole 24. The fastener can be screw, rivet or any other fastener, which can facilitate the assembly function and at least one fastener is used to facilitate the assembly.

The stator base 4 is assembled to the worm gear 100 by fastener 95, which can be screw, rivet or any other fastener, which can facilitate the assembly function and at least one fastener is used to facilitate the assembly. The rotor core 80 is mounted to the worm gear 100 by means of the pivot shaft 97, which is locked in place by the washer 98 and the OD retainer 96. The pivot shaft 97 is part of the rotor core 80 by assembly, casting, molding or welding. The material choice for the rotor core 80 and the pivot shaft 97 can be hard plastic, graphite or metal. Phosphorus bronze and stainless steel are the best material choice for the pivot shaft 97. The rotor core 80 rotates through the center axis of the pivot shaft 97. The ID of the center hole of the worm gear 100 is slightly larger than the OD of the pivot shaft 97 and serves as the bearing surface 99 mating to the OD of the pivot shaft 97. The worm gear can be made of hard plastic, graphite or metal. Phosphorus bronze and stainless steel are the best material choice for this worm gear 100. Gear lubricant, grease or Teflon coating is applied to the bearing surface 99 and the OD of the pivot shaft 97 to minimize friction.

The horizontal motion motor-driver subassembly 27 is mounted to the rotor core 80 and provides the rotational direction to the rotor core 80. As a result the rotor core 80 rotates relatively to the stator base 4.

The mechanical seal 21 is mounted between the external wall 25 of the stator base 4 and the internal wall 20 of the top cover 11. This mechanical seal 21 can be lip seal, O-ring, water-tight seal, air-tight seal, ferrofluid seal and other seals that can facilitate the sealing function. The mechanical seal 21 stops foreign matters from entering into the inside chamber of the main system 1.

The horizontal motion motor-driver subassembly 27 and the vertical motion motor-driver subassembly 19 are electrically connected to the PCBA 12 by wire harness 101 and wire harness 82 respectively. The main PCBA 12 is mounted onto the rotor core 80 by fastener 102. The main PCBA 12 is consisted of electronic components, programmable component, signal receiver, decoder and firmware which will receive wireless signals 48 and encoded signal 6 and then transfer them into electronic signal to drive the horizontal motion motor-driver subassembly 27 and the vertical motion motor-driver subassembly 19 respectively. The vertical motion motor-driver assembly 19 is supported by the rotor core 80.

The worm gear 77 rotates against the center axis of the pivot shaft 143. The ID of the center hole of the worm gear 77 is slightly larger than the OD of the pivot shaft 143 and serves as the bearing surface 54 mating to the OD of the pivot shaft 143. This pivot shaft 143 is made of metal and stainless steel is the best choice. The worm gear 77 can be made of hard plastic like ABS or metal. Phosphorus bronze and stainless steel are the best material choice for this worm gear 77. Gear lubricant, grease or Teflon coating is applied to the bearing surface 54 and the OD of the pivot shaft 143 to minimize friction.

The top cover II is mounted to the rotor core 80 by at least one fastener. The inner vertical wall 20 of top cover II covers over the lips of the seal 21 and is illustrated in Detail 2 of FIG. 7. The battery holder 105 of the top cover 11 supports the rechargeable battery 106. The battery 106 is connected to the PCBA 12 by the battery cable 104. This battery 106 provides power to the system when live electrical power supply is interrupted or discontinued. The PCBA 12 is equipped with components to charge up the rechargeable battery 106 when live AC or DC power supply is provided to the main system 1.

The live AC or DC power is supplied to the main system 1 by the control cable 23 through wire 93, 92 and 91 which is connected to the circular conductor pad 86, 87 and 88 through the conductor lead 94, 89 and 90. The conductor housing 84 of the spring loaded contact mechanism 79 is mounted to the rotor core 80 by fastener 81. The spring loaded contact conductor 85 of the spring loaded contact mechanism 79 is connected to the PCBA 12 through the wire 83 and is always in contact with circular conductor pad 86. Exact detail is illustrated in Detail 1 of FIG. 6. One set of spring loaded contact mechanism 79 is shown in FIG. 2; however, in practice, every circular conductor pad 86 (same as 87 and 88) requires one set of spring loaded contact mechanism 79 and connection to the PCBA 12 by wire 83. In practice, it is user's choice to determine the requirement of number of wire 93 (same as 91 and 92), conductor lead 94 (same as 89 and 90), circular conductor pad 86 (same as 87 and 88) sets and spring loaded contact mechanism 79 to be used in the system. Furthermore, it is user's choice to determine the function of each of the above conductor mechanism to be used as power supply, ground or signal transmission.

Conductor lead 74 and conductor lead 75 are mounted to the mounting stage 14 and is connected to the PCBA 12 by conductor wire 73 and wire 76. Two sets of this conductor lead and conductor wire are shown in FIG. 2; and the exact quantity is to be determined by the user. This conductor lead 74 and conductor lead 75 can be used as providing power supply, grounding or signal transmission to the utility equipment 5, which is to be mounted onto the mounting stage 14.

The elastic boot cover 16 is assembled to the mounting stage 14 with its edge 72 sealed against foreign matter from entering into the inside chamber. The assembly can be manufactured by molding, clamping, adhesive or other assembly means to facilitate the assembly. The bottom flange of the elastic boot cover 16 is mounted to the top cover 11 by clamping bracket 17 and fastener 13. The fastener 13 can be screw, rivet or any other fastener, which can facilitate the assembly function and at least one fastener is used to facilitate the assembly.

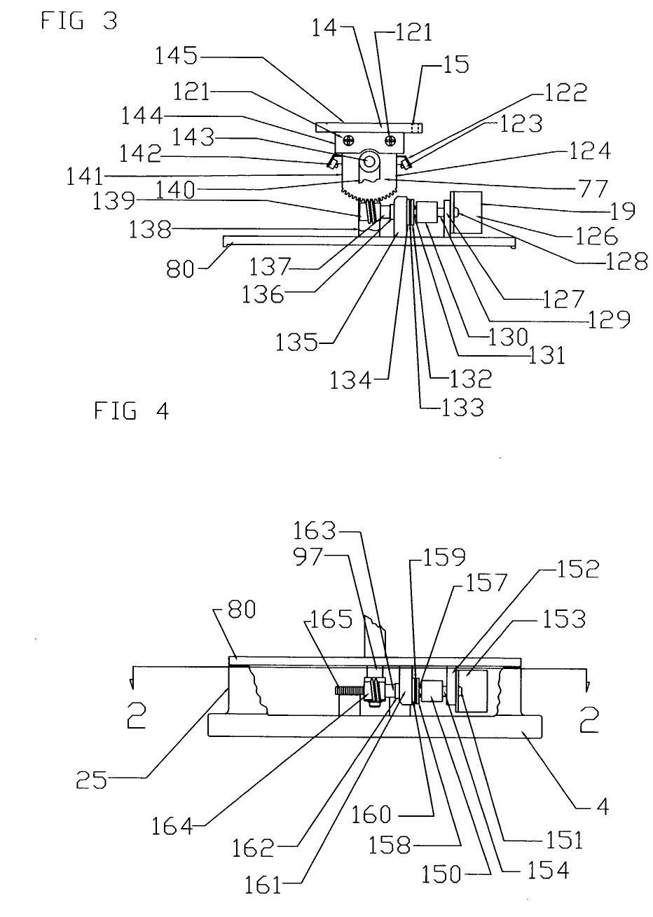

FIG. 3 is the isolated view of FIG. 2 of the vertical rotational motion power transmission system. The motor 126 is mounted to the rotor core 80 by fastener 128 to motor support arm 127. The worm shaft 137 is assembled to the ID of the mechanical bearing 136. The OD of the mechanical bearing 136 is assembled to the bearing support 135. The mechanical bearing 136 can be plastic bearing, precision bushing, journal bearing, ball bearing or other bearing type mechanism to facilitate the bearing function. It is located in place by the washer 134, spring washer 133, washer 132 and OD retainer 131. The end of the worm shaft 137 is attached to torque coupler 130. The other end of the torque coupler 130 is connected to the motor shaft 129. The torque coupler 130 transmits the motor power to the worm 139 and can tolerate any axial misalignment between the axis of the motor 126 and the axis of the worm 139. This torque coupler 130 can be bellow coupling, flexible shaft coupling or other coupling type mechanism to facilitate the above function.

The mounting stage 14 is assembled to the worm gear 77 by fastener 121, which can be screw, rivet or any other fastener that can facilitate the assembly function and at least one fastener is used to facilitate the assembly. The mounting surface 145 and mounting hole 15 are provided for supporting the installation of the utility equipment.

The worm 139 rotates at the same rate as the motor 126 and the worm gear 77 will pivot to the next tooth for every rotation of the worm 139. As results, the mounting stage 14 pivots referencing to the pivot shaft 143 whenever the motor 126 rotates. In practice worm gear system provides two advantages to the invention. Firstly, it prevents gear slippage and in turn the electronic system does not have to provide motor holding current to keep the mounting stage 14 to lock in the prefer tilted angular position. This is an unique power saving feature of this invention. Secondly, it provides a very high gear ratio such that a very low output torque motor 126 will be able to tilt the mounting stage 14.

The clockwise limit switch 142 and the counterclockwise limit switch 123 are mounted to the bracket 122, which is supported by the support frame 138 of the rotor core 80. Both switches are electrically connected to the PCBA 12.

The left edge 141 of the worm gear 77 will touch and activate the clockwise limit switch 142 as the motor 126 keeps driving the worm gear 77 in pivoting in the clockwise movement direction. The clockwise limit switch 142, which is connected to PCBA 12, will send an electrical signal to the PCBA 12. The PCBA 12 is preprogrammed to stop the motor 126 to keep rotating any further in the clockwise direction.

The right edge 124 of the worm gear 77 will touch and activate the counterclockwise limit switch 123 as the motor 126 keeps driving the worm gear 77 in pivoting in the counterclockwise movement direction. The counterclockwise limit switch 123, which is connected to PCBA 12, will send an electrical signal to the PCBA 12. The PCBA 12 is preprogrammed to stop the motor 126 to keep rotating any further in the counterclockwise direction. The amount of allowable tilt angle of the mounting stage 14 is defined as the angle of rotation between the activation of the clockwise limit switch 142 by the left edge 141 of the worm gear 77 and the activation of the counter clockwise limit switch 123 by the right edge 124 of the worm gear 77. A 70-degree allowable tilt angle is shown in FIG. 3.

As switch 36 or switch 37 of the remote controller 2 receives an input signal from the operator, the remote controller 2 will emit the encoded signal 6. The main PCBA 12 of the main system 1 will decode the signal 6 and provide an electrical function to the motor 126. As a result, the mounting stage 14 will tilt relatively to the stator base 4 accordingly.

As switch 50 or switch 51 of the wireless remote controller 3 receives an input signal from the operator, the wireless remote controller 3 will emit the encoded wireless signal 48. The main PCBA 12 of the main system 1 will detect and decode the signal 48; and provide an electrical function to the motor 126. As a result, the mounting stage 14 will tilt relatively to the stator base 4 accordingly.

FIG. 4 is the front view with a portion of the stator wall 25 cutout to show the mechanism inside. This figure illustrates the worm gear driven horizontal polar motion mechanism 27. The motor 153 is mounted to the rotor core 80 by fastener 151 to motor support arm 152. The worm shaft 163 is assembled to the ID of the mechanical bearing 162. The OD of the mechanical bearing 162 is assembled to the bearing support 161 of the rotor core 80. The mechanical bearing 162 can be plastic bearing, precision bushing, journal bearing, ball bearing or other bearing type mechanism to facilitate the bearing function. It is located in place by the washer 160, spring washer 159, washer 158 and OD retainer 157. The end of the worm shaft 163 is attached to torque coupler 150. The other end of the torque coupler 150 is connected to the motor shaft 154 as shown in FIG. 4. The torque coupler 150 transmits the motor power to the worm 164 and can tolerate any axial misalignment between the axis of the motor 153 and the axis of the worm 164. This torque coupler 150 can be bellow coupling, flexible shaft coupling or other coupling type mechanism to facilitate the above function.

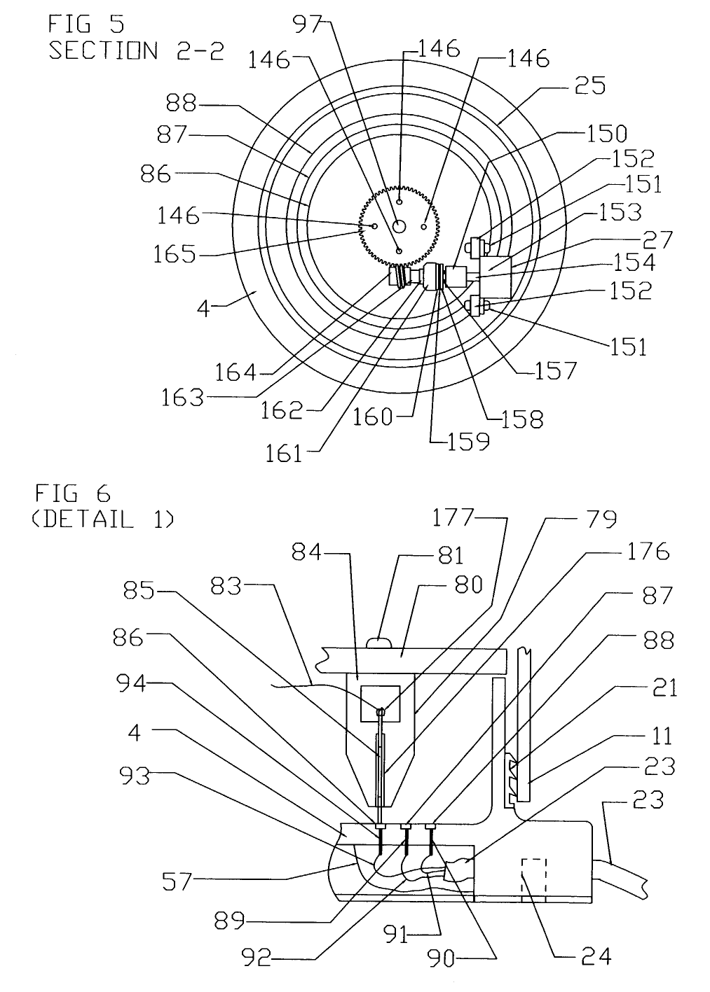

FIG. 5 is the top section view of FIG. 4 along 2-2. The worm gear 165 is mounted to the stator base 4 at the mounting holes 146 by at least one fastener 95, which can be screw, rivet or other mounting mechanisms to facilitate the assembly. As the result, the worm gear 165 is the fixed and is the stationary base of the horizontal rotational movement.

The worm 164 rotates at the same rate as the motor 153 and the worm gear 165 will pivot to the next tooth for every rotation of the worm 164. In the assembly the worm 164 and the worm gear 165 with the same pitch value are precisely mated to each other. The rotor core 80 and all the components assembled to the rotor core 80 rotate around the worm gear 165 referencing to the center axis of the pivot shaft 97 whenever the motor 153 rotates. In practice, worm gear system provides two advantages to the invention. Firstly, it prevents gear slippage and in turn the electronic system does not have to provide motor holding current to keep the main system 1 to lock in position. This is an unique power saving feature of this invention. Secondly, it provides a very high gear ratio such that a very low output torque motor 153 will be able to rotate the main system 1.

As shown in FIG. 5, this system of rotor core 80 with all the components assembled to it can rotate relatively to the stator base 4 in either clockwise or counterclockwise direction without angular limitation.

As switch 39, switch 40, switch 43 or switch 42 of the remote controller 2 receives a signal from the operator, the remote controller 2 will emit the encoded signal 6. The main PCBA 12 of the main system 1 will decode the signal 6 and provide an electrical function to the motor 153. As a result, the mounting stage 14 will rotate relatively to the stator base 4 accordingly.

As switch 44, switch 45, switch 46 or switch 47 of the wireless remote controller 3 receives a signal from the operator, the wireless remote controller 3 will emit the encoded wireless signal 48. The main PCBA 12 of the main system 1 will detect and decode the signal 48; and provide an electrical function to the motor 153. As a result, the mounting stage 14 will rotate relatively to the stator base 4 accordingly.

Each conductor pad 86, 87 and 88 is a round shape metal conductor attached to the top of the stator base 4 and are concentric to the axis of the shaft 97 and their surfaces lie on the plane perpendicular to the axis of the shaft 97. These conductors can be metallic traces of a PCB or metal rings, which can facilitate the function of a conductor. The mechanic of the conductor connection is illustrated in Detail 1 (FIG. 6).

FIG. 6 is the Detail 1 view of the section portion of FIG. 2 illustrating the electrical conduction mechanism from the signal cable 23 to the wire 83 connecting to the PCBA 12.

The wire 93, wire 92 and wire 91 of the control cable 23 is connected to the circular conductor pad 86, circular conductor pad 87, and circular conductor pad 88 through the conductor lead 94, conductor lead 89 and conductor lead 90 respectively. The conductor housing 84 of the spring loaded contact mechanism 79 is mounted to the rotor core 80 by fastener 81. The guide channel 176 of the conductor housing 84 provides a physical confinement for the spring loaded contact conductor 85 such that its contacting tip can only extend or contract vertically and cannot move or bend sideways. This feature allows the contacting tip of the spring loaded contact conductor 85 to be in contact with the circular conductor pad 86 all the time even when the distance between the conductor housing 84 and the circular conductor pad 86 changes due to components tolerance. The other end of the spring loaded contact conductor 85 is connected to the wire 83 by soldering or other bonding means to facilitate a perfect electrical connection 177. In results that there is always uninterrupted electrical connection between the wire 93 of the control cable 23 and wire 83 which leads to the PCBA 12.

One set of spring loaded contact mechanism 79 is shown in the illustration; however, in practice, every circular conductor pad 86 (same as 87 and 88) requires one set of spring loaded contact mechanism 79 and connection to the PCBA 12 by wire 83. In the same token, wire 91 and wire 92, which have the same quality as the wire 93 are connected to the PCBA 12 with uninterrupted electrical connection.

In practice, it is user's choice to determine the requirement of number of wire 93, conductor lead 94, circular conductor pad 86 sets and spring loaded contact mechanism 79 to be used in the system. Furthermore, it is user's choice to determine the function of each of the above conductor mechanism to be used as power supply, ground or signal transmission.

The exposed end of the control cable 23, the wires 93, 92, 91 and the conductor leads 94, 89, 90 are encapsulated by encapsulation resin 57. Advantageously, after the resin has set and cured, all the openings for the leads to feed through are watertight and all components are protected by the encapsulation resin against water and most mild chemicals.

FIG. 7 is the Detail 2 view of the section portion of FIG. 2 illustrating the magnetic latch 7 of the stator base 4 and the sealing mechanic of the mechanical seal 21.

The mechanical seal 21, is assembled to the external surface of the vertical wall 25 of the stator base 4. The assembly can be by adhesive, clamping, heat staking, fastener or other assembly method that can facilitate the assembly to keep the mechanical seal 21 in place. This mechanical seal 21 is made of elastic material like rubber, silicon rubber, Teflon, Viton, nylon, polyester or any other material that can facilitate the sealing action. The lip 175 is a protruded section of the mechanical seal 21. It is designed to be a lip seal against the internal wall 20 of the top cover 11. This lip 175 seals off dust, rain and foreign matters from the ambient. In the illustration, 3 lip 21 protrusions are shown; however it is user's choice to determine the number of lips 3 to be used. The OD of the external surface of the vertical wall 25 of the stator base 4 is concentric to the internal wall 20 of the top cover 11 in main system 1. In results, the mechanical seal 21 is concentric to the internal wall 20 of the top cover 11 in the main system 1. During the operation the lip 175 is always exerting a positive pressure against the internal wall 20 of the top cover 11 whether the top cover 11 is rotating against the stator base 4 or not. In practice, the mechanical seal 21 can be O ring, lip seal or any other seal that can facilitate the sealing function against dust, fluid and foreign matters for the main system 1.

The magnetic latch 7 is consisted of the magnet 30, magnet 31, the flux retainer 32 and the surrounding non-magnetic permeable material 70 of the stator base 4. The S pole of the magnet 30 is in contact with the flux retainer 32, which is made of a magnetic permeable material. The N pole 173 of the magnet 30 is even with the bottom surface of the cushion footpad 29. The N pole 173 of the magnet 30 is exposed and will adhere to any magnetic permeable material. The N pole of the magnet 31 is in contact with the flux retainer 32. The S pole 174 of the magnet 31 is even with the bottom surface of the cushion footpad 29. The S pole 174 of the magnet 31 is exposed and will adhere to any magnetic permeable material. The magnet 30, magnet 31 and the flux retainer 32 are surrounded by the non-magnetic permeable material 70 in the stator base 4. The stator base 4 can be made of non-magnetic permeable material 70 or this non-magnetic permeable material 70 is locally implanted into the stator base 4 to support the magnetic latch function.

As the stator base 4 is rested on top of a magnetic permeable surface such as the sheet metal steel top of a car. The magnetic force from the N pole 173 of the magnet 30 and the S pole 174 of the magnet 31 will attract to the steel top of the car as the magnetic latching function. The metal top becomes the local flux retainer of the magnetic circuit. This system provides the maximum magnetic strength with the minimum magnetic flux leakage to the ambient. The magnet 30 and magnet 31 can be made of metal, rubber, ceramic or any other type of magnet with magnetic properties.

The cushion footpad 29 is adhered to the bottom of the stator base 4 provides a gasket layer between the bottom surface of the stator base 4 and the surface which the stator base 4 is mounted on. It also provides a cushion to withstand any minor irregularity of the resting surfaces. This cushion footpad 29 is made of soft material like rubber, silicon rubber or any other padding material, which can provide the said functions as the cushion footpad 29.

FIG. 8 is the bottom view of the stator base 4 of the main system 1. At least one mounting hole 24 is provided for the user to have a choice to mount the main system to a surface by fastener. As shown in the figure, 6 mounting holes 24 are provided. One 1/4-20 UNC internal threaded hole 180 is provided for generic tripod mounting. One guide hole 179 for generic tripod mounting orientation is provided. The N pole 173 and the S pole 174 of the magnetic latch 7 are exposed for mounting by magnetic force. In practice, it is user's choice to define the bolt patent of the S pole 174 and the N pole 173, the number of occurrences and the bolt circle diameters. 6 sets of magnetic latches are shown in the illustration. The cushion footpad 29 covers all the rest of the contact surface of the stator base 4 except the S pole 174 and the N pole 173 of the magnetic latches and the mounting holes 24. The surface of the cushion footpad 29 is textured for maximum friction against sliding and slippage when the main system 1 is placed onto any surface.

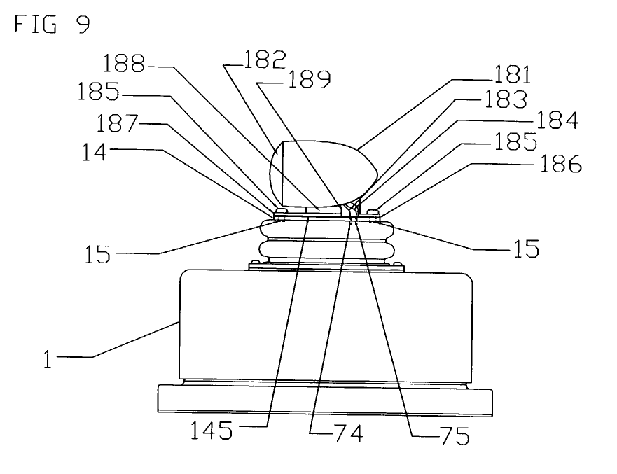

FIG. 9 is the front view of the main system 1 with an utility lamp 181 mounted to the mounting stage 14 illustrating the usage of the invention. The flange 187 of the utility lamp 181 is mounted to the top surface 145 of the mounting stage 14 by fastener 185. Gasket 186 is placed between the flange 187 and the mounting stage 14 to seal off foreign matters. The support section 188 supports the light module 182 of the utility lamp 181. The cutout 189 of the support section 188 exposes the inside wire connections of the utility lamp 181. The positive lead wire 183 of the lamp 181 is connected to the conductor lead 74 and the negative lead wire 184 is connected to the conductor lead 75. The utility lamp 181 will light up whenever power is supplied to the conductor lead 74 and conductor lead 75.

The following is an example of functional illustration of “How to use” this invention with the initial condition setup for a remote-control utility equipment mounting apparatus with an utility lamp mounted on:

Firstly, electrical power is supplied to the power cable 33 and setting the functions of the switches as following:

Switch 44 correlated to switch 39 to rotate the mounting stage 14 clockwise

Switch 45 correlated to switch 40 to jog the mounting stage 14 clockwise

Switch 46 correlated to switch 43 to rotate the mounting stage 14 counterclockwise

Switch 47 correlated to switch 42 to jog the mounting stage 14 counterclockwise

Switch 50 correlated to switch 36 to tilt the mounting stage 14 upward

Switch 51 correlated to switch 37 to tilt the mounting stage 14 downward

Switch 52 correlated to switch 41 and is dedicated for blinking lamp on and off

Switch 53 correlated to switch 38 and is dedicated for lamp on and off

The utility lamp 181 is mounted to the main system as in FIG. 9.

The main system 1 is mounted to the sheet metal roof of a car by the magnetic latches.

After completion of the above initial setup, the user can remotely control the utility lamp with pan and tilt functions by the remote controller or the wireless remote controller. The user can turn the utility lamp 181 on or off by switch 52 or switch 41; and can let the utility lamp 181 to blink or stop by switch 53 or switch 38.

This design provides an easy operation for mounting and dismounting the whole system onto the sheet metal roof of a vehicle as well as the remote-controllability of the pan and tilt functions of this illumination system.

It will be appreciated that the sizes and shapes and dispositions of various main system, wireless remote controller and non-wireless remote controller can be varied, without departing from the spirit and scope of the invention. Similarly, the size and location of mounting holes, housing, elastic boot cover, magnetic latches, material protrusions and the like may be varied. While the sealing of the inner spaces has been described with respect to use of gaskets, adhesive or seal, other sealing mechanisms may instead (or in addition) be used. While the remote control utility equipment mounting apparatus has been described with respect to application with utility lamp, the described system may be applied to other utility equipment, including without limitation to supply mounting for antenna, surveillance equipment, infrared sighting equipment, rifles, boating equipment and radar equipment.

Modifications and variations may be made to the disclosed embodiments without departing from the subject and spirit of the invention as defined by the following claims.

What is claimed is:

1. A remote-control utility equipment mounting apparatus comprising:
A stator base subassembly as the stationary support of said device.
A rotor subassembly rotates horizontally relative to the stator base.
A first electric motor, which is supported within the rotor subassembly, is coupled to power drive transmission mechanism, rotates the rotor subassembly relatively to the stator base without angular limitation.
A mechanical linkage is supported within the rotor subassembly and is perpendicular to the stator base, rotates through an axis parallel to the stator base.
A second electric motor, which is supported within the rotor subassembly, is coupled to power drive transmission mechanism, rotates the above said mechanical linkage vertically against the above said axis relatively to the stator base.
A mounting stage subassembly, which is supported by the said mechanical linkage, provides mounting base mechanism to utility equipment.
A PCBA equipped with signal receiver, which can be radio frequency signals receiver and/or infrared (IR) signals receiver, electronic components, firmware to receive the said wireless signals and electronic signals and generate electronic functions to drive the first electrical motor to perform the horizontal rotation and the second electrical motor to perform the vertical rotation of the said mechanical linkage.
An electrical conduction system with spring loaded conductor contacts pushing against concentric circular conductor pads.
A rechargeable battery in a battery holder, which is supported by the rotor subassembly, provides electrical power to the PCBA when live electrical power is interrupted.
A remote controller apparatus is equipped with electronic components, firmware, electronic signal connector and electrical switches to receive user input directly from the switches or from external equipment; and then generates signals and sends the said signals to the main system through a signal cable.
A wireless remote controller apparatus is equipped with electronic components, firmware, electronic signal connector and electrical switches to receive user input directly from the switches or from external equipment; and then generate wireless signals, which can be radio frequency signals and/or infrared (IR) signals, and then emit the said signals out.
An internal threaded hole and a guide hole are provided in the center area of the bottom of the stator base to accommodate the generic mounting means of generic tripod.
An elastic boot cover protects the said main system and seals foreign matters from entering into the inside chambers of the said main system.

2 The apparatus of claim 1, wherein said the said utility equipment mounting apparatus also includes battery powered utility equipment mounting apparatus, solar powered utility equipment mounting apparatus, portable utility equipment mounting apparatus, AC powered utility equipment mounting apparatus and DC powered utility equipment mounting apparatus.

3 The apparatus of claim 1, wherein said the power transmission mechanism of the said first electrical motor is coupled by a torque coupler within the chain of mechanism to tolerate the axial misalignment between the said motor and the rest of the mechanism for the provision of the horizontal rotary motion of an utility equipment mounting apparatus.

4 The apparatus of claim 1, wherein said power transmission mechanism of the said second electrical motor is coupled by a torque coupler within the chain of mechanism to tolerate the axial misalignment between the said motor and the rest of the mechanism for the provision of vertical rotary motion of an utility equipment mounting apparatus.

5 The apparatus of claim 3, wherein said a worm and worm gear system is part of the power transmission mechanism coupled to the said first electrical motor for the provision of the horizontal rotary motion of an utility equipment mounting apparatus.

6 The apparatus of claim 5, wherein said a method of utilizing a worm and worm gear system as part of the power transmission mechanism coupled to the said first electrical motor for the provision of the horizontal rotary motion of a utility equipment mounting apparatus in a remote-controllable utility equipment mounting apparatus:
The remote-controllable utility equipment mounting apparatus also includes wirelessly remote-controllable utility equipment mounting apparatus and non-wirelessly remote-controllable utility equipment mounting apparatus.
A non-wirelessly remote controller device generates signals and transmits the signals out by conductor cables or fiber-optic cables.
A wireless remote controller device generates signals, which also include radio frequency signals, infrared (IR) signals and emits the said signals wirelessly.
An utility equipment mounting apparatus main unit detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said remote controller to the said utility equipment mounting device without passing through at least one electric conductor or fiber-optic cable directly and/or indirectly.
The said utility equipment mounting apparatus also includes battery powered utility equipment mounting apparatus, solar powered utility equipment mounting apparatus, portable utility equipment mounting apparatus, AC powered utility equipment mounting apparatus and DC powered utility equipment mounting apparatus.

7 The apparatus of claim 5, wherein said first electrical motor does not require electrical holding current applied to the said motor in order to prevent mechanical slippage of the said first electrical motor and power transmission mechanism for the provision of the horizontal rotary motion of an utility equipment mounting apparatus.

8 The apparatus of claim 4, wherein said a worm and worm gear system is part of the power transmission mechanism to the said second electrical motor for the provision of vertical rotary motion of an utility equipment mounting apparatus.

9 The apparatus of claim 8, wherein said a method of utilizing a worm and worm gear system as part of the power transmission mechanism coupled to the said second electrical motor for the provision of the vertical rotary motion of an utility equipment mounting apparatus in a remote-controllable utility equipment mounting apparatus:
The remote-controllable utility equipment mounting apparatus also includes wirelessly remote-controllable utility equipment mounting apparatus and non-wirelessly remote-controllable utility equipment mounting apparatus.
A non-wirelessly remote controller device generates signals and transmits the signals out by conductor cables or fiber-optic cables.
A wireless remote controller device generates signals, which also include radio frequency signals, infrared (IR) signals and emits the said signals wirelessly.
An utility equipment mounting apparatus detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said remote controller to the said utility equipment mounting device without passing through at least one electric conductor or fiber-optic cable directly and/or indirectly.
The said utility equipment mounting apparatus also includes battery powered utility equipment mounting apparatus device, solar powered utility equipment mounting apparatus, portable utility equipment mounting apparatus, AC powered utility equipment mounting apparatus and DC powered utility equipment mounting apparatus.

10 The apparatus of claim 8, wherein said second electrical motor does not require electrical holding current applied to the said motor in order to prevent mechanical slippage of the said second electrical motor and power transmission mechanism for the provision of vertical rotary motion of an utility equipment mounting apparatus.

11 The apparatus of claim 1, wherein said the main system is equipped with a mechanical seal between the said stator base and the said rotor subassembly to seal off foreign matters from entering into the inside chambers of an utility equipment mounting apparatus.

12 The apparatus of claim 1 wherein said the said mechanical seal includes air-tight seal, water-tight seal, ferro-fluid seal, lip seal, lip seal with restrainer, O-ring seal, Teflon seal, Viton seal, silicon rubber seal and graphite seal.

13 The apparatus of claim 1, wherein said at least one limit switch is used to set and detect the vertical rotational limit of the said mechanical linkage of vertical rotary motion of an utility equipment mounting apparatus.

14 The apparatus of claim 1, wherein said at least portion of the said elastic boot cover is made of soft material to allow bending and folding of the said cover of an utility equipment mounting apparatus.

15 The apparatus of claim 14, wherein said the said elastic boot cover can comprise of more than on piece part assembled together.

16 The apparatus of claim 14, wherein said at least a portion of the said cover material can be transparent to allow the portion of the utility equipment mounting apparatus covered by the said cover to be visible.

17 The apparatus of claim 14, wherein said the entire said elastic boot cover or at least portion of the said elastic boot cover is made of elastic material such as rubber, polyester, nylon and silicon rubber alike.

18 The apparatus of claim 1, wherein said the said wireless remote controller comprises
It receives input from user through at least one electrical switch.
It receives input from external equipment through signal connector.
It generates radio frequency signals.
It emits the signals wirelessly to an utility equipment mounting device with a radio frequency signal receiver to drive a servo motor or a stepper motor, which is coupled to power transmission mechanism to perform horizontal rotational clockwise and counterclockwise movements of a rotary stage relatively to a stationary base.

19 The apparatus of claim 18, wherein said the said wireless remote controller is a variable speed controller.

20 The apparatus of claim 1, wherein said the said wireless remote controller comprises:
It receives input from user through at least one electrical switch.
It receives input from external equipment through signal connector.
It generates infrared (IR) signals.
It emits the signals wirelessly to an utility equipment mounting device with an infrared (IR) signal receiver to drive a servo motor or a stepper motor, which is coupled to power transmission mechanism to perform horizontal rotational clockwise and counterclockwise movements of a rotary stage relatively to a stationary base

21 The apparatus of claim 20, wherein said the said wireless remote controller is a variable speed controller.

22 The apparatus of claim 1, wherein said the said wireless remote controller comprises
It receives input from user through at least one electrical switch.
It receives input from external equipment through signal connector.
It generates radio frequency signals.
It emits the signals wirelessly to an utility equipment mounting apparatus with a radio frequency signal receiver to drive a servo motor or a stepper motor, which is coupled to power transmission mechanism to perform vertical rotational clockwise and counterclockwise movements of a mechanical linkage supported within the said utility equipment mounting apparatus with a pivoting axis parallel to the stationary base.

23 The apparatus of claim 22, wherein said the said wireless remote controller is a variable speed controller.

24 The apparatus of claim 1, wherein said the said wireless remote controller comprises
It receives input from user through at least one electrical switch.
It receives input from external equipment through signal connector.
It generates infrared (IR) signals.
It emits the signals wirelessly to an utility equipment mounting apparatus with a infrared (IR) signal receiver to drive a servo motor or a stepper motor, which is coupled to power transmission mechanism to perform vertical rotational clockwise and counterclockwise movements of a mechanical linkage supported within the said utility equipment mounting apparatus with a pivoting axis parallel to the stationary base.

25 The apparatus of claim 24, wherein said the said wireless remote controller is a variable speed controller.

26 The apparatus of claim 1, wherein said a remote controller comprises:
It receives input from user through at least one electrical switch.
It receives input from external equipment through signal connector.
It generates electrical signals and encoded signals.
It sends the said signals to an utility equipment mounting apparatus through a signal cable to drive a servo motor or a stepper motor, which is coupled to power transmission mechanism to perform vertical rotational clockwise and counterclockwise movements of a mechanical linkage supported within the said utility equipment mounting apparatus with a pivoting axis parallel to the stationary base

27 The apparatus of claim 26, wherein said the said remote controller is a variable speed controller.

28 The apparatus of claim 1, wherein said the said remote controller comprises
It receives input from user through at least one electrical switch.
It receives input from external equipment through signal connector.
It generates electrical signals and encoded signals.
It sends the said signals to an utility equipment mounting apparatus through a signal cable to drive a servo motor or a stepper motor, which is coupled to power transmission mechanism to perform horizontal rotational clockwise and counterclockwise movements of a rotary stage relatively to a stationary base.

29 The apparatus of claim 28, wherein said the said remote controller is a variable speed controller.

30 The apparatus of claim 1, wherein said an electrical motor driven rotor subassembly of a battery powered horizontal rotary utility equipment mounting stage can rotate clockwise and counterclockwise relatively to its stationary base with no angular limitation.

31 The apparatus of claim 1, wherein said the said utility equipment mounting apparatus:
Receives radio frequency signals wirelessly.
Generates electrical functions to drive at least one servo motor or a stepper motor to perform horizontal rotational motion and/or vertical rotational motion.

32 The apparatus of claim 31, wherein said the said utility equipment mounting apparatus also include battery powered utility equipment mounting apparatus, solar powered utility equipment mounting apparatus, portable utility equipment mounting apparatus, AC powered utility equipment mounting apparatus and DC powered utility equipment mounting apparatus.

33 The apparatus of claim 1, wherein said the said utility equipment mounting apparatus:
Receives infrared (IR) signals wirelessly.
Generates electrical functions to drive at least one servo motor or a stepper motor to perform horizontal rotational motion and/or vertical rotational motion.

34 The apparatus of claim 33, wherein said the said utility equipment mounting apparatus also include battery powered utility equipment mounting apparatus, solar powered utility equipment mounting apparatus, portable utility equipment mounting apparatus, AC powered utility equipment mounting apparatus and DC powered utility equipment mounting apparatus.

35 The apparatus of claim 1, wherein said the bottom surface of the said utility equipment mounting apparatus provides at least one threaded mounting hole to adapt the threaded fastener provide by generic tripod.

36 The apparatus of claim 35, wherein said the said threaded mounting hole is of 1/4-20 UNC internal thread.

37 The apparatus of claim 1, wherein said the bottom surface of the said utility equipment mounting apparatus provides at least one hole to adapt the guide pin provide by generic tripod for mounting orientation.

38 The apparatus of claim 1, wherein said the bottom surface of the said stator base subassembly of the said utility equipment mounting apparatus is equipped with at least one magnetic latch which is defined as a mechanism of exerting magnetic force to a magnetic permeable surface.

39 The apparatus of claim 38, wherein said the said magnetic latch includes at least one magnet for exerting magnetic force to a magnetic permeable material surface as the holding force of the said utility equipment mounting apparatus to the said magnetic permeable surface.

40 The apparatus of claim 39, wherein said a method of holding down a remote-controllable utility equipment mounting apparatus by at least one magnetic latch:
The said remote-controllable utility equipment mounting apparatus includes wirelessly remote-controllable utility equipment mounting apparatus and non-wirelessly remote-controllable utility equipment mounting apparatus.
A non-wirelessly remote controller device generates signals and transmits the signals out by conductor cables or fiber-optic cables.
A wireless remote controller device generates signals, which also include radio frequency signals, infrared (IR) signals and emits the said signals wirelessly.
An utility equipment mounting apparatus detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said wirelessly remote controller to the said utility equipment mounting apparatus without passing through at least one electrical conductor or fiber-optic cable directly and/or indirectly.
The said utility equipment mounting apparatus also includes battery powered utility equipment mounting apparatus device, solar powered utility equipment mounting apparatus, portable utility equipment mounting apparatus, AC powered utility equipment mounting apparatus and DC powered utility equipment mounting apparatus

41 The apparatus of claim 1, wherein said the said electrical conduction system with spring loaded conductor contacts pushing against concentric circular conductor pads has at least one spring loaded conductor contact mounted onto the rotor subassembly.

42 The apparatus of claim 41, wherein said the said electrical conduction system with a spring loaded conductor contact pushing against a concentric circular conductor pad has at least one concentric circular conductor pad mounted onto the stator base subassembly

43 The apparatus of claim 42, wherein said the geometric center of the said concentric circular conductor pad lies on the same axis of rotation of the rotor subassembly relatively to the stator base subassembly.

44 The apparatus of claim 43, wherein said the said concentric circular conductor pad surface lies on a plane perpendicular to the axis of rotation of the rotor subassembly relatively to the stator base subassembly.

45 The apparatus of claim 44, wherein said the said distance between the spring loaded conductor contact and the said axis of rotation is equal to the radius of the concentric circular conductor pad.

46 The apparatus of claim 45, wherein said the said spring loaded conductor contact is in contact electrically with the said concentric circular conductor pad.

47 The apparatus of claim 46, wherein said the said spring loaded conductor contact is exerting a spring force against the said concentric circular conductor pad in order to keep the said conductor contact in contact with the said concentric circular conductor pad all the time.

48 The apparatus of claim 47, wherein said a method of electrical conduction between the stator base subassembly and the rotor subassembly of a remote-controllable utility equipment mounting apparatus by using an electrical conduction system with spring loaded conductor contacts pushing against a concentric circular conductor pads:
The said remote-controllable utility equipment mounting apparatus includes wirelessly remote-controllable utility equipment mounting apparatus and non-wirelessly remote-controllable utility equipment mounting apparatus.
A non-wirelessly remote controller device generates signals and transmits the signals out by conductor cables or fiber-optic cables.
A wireless remote controller device generates signals, which also include radio frequency signals, infrared (IR) signals and emits the said signals wirelessly.
An utility equipment mounting apparatus detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said wirelessly remote controller to the said utility equipment mounting apparatus without passing through at least one electric conductor or fiber-optic cable directly and/or indirectly.
The said utility equipment mounting apparatus also includes battery powered utility equipment mounting apparatus device, solar powered utility equipment mounting apparatus, portable utility equipment mounting apparatus, AC powered utility equipment mounting apparatus and DC powered utility equipment mounting apparatus.

49 The apparatus of claim 1, wherein said conductor leads, which are electrically connected from the PCBA are provided at the said mounting stage subassembly.

50 The apparatus of claim 49, wherein said the said conductor leads can be used as power supply source, grounding source and signal controlling source for the utility equipment to be mounted on.

51 The apparatus of claim 1, wherein said the said utility equipment mounting apparatus is for mounting use of utility illumination system.

52 The apparatus of claim 51, wherein said the said utility illumination system includes driving lamp, utility lamp, fog lamp, spotting lamp, halogen lamp, flood lamp, search lamp, high intensity lamp and high intensity discharge lamp.

53 The apparatus of claim 51, wherein said the method of a remote-control utility illumination system:
The remote controller includes wirelessly remote controller and non-wirelessly remote-controller.
A non-wirelessly remote controller device generates signals and transmits the signals out by conductor cables or fiber-optic cables.
A wirelessly remote controller device generates signals, which also include radio frequency signals, infrared (IR) signals and emits the said signals wirelessly.
A main system, with pan and tilt functions, supports the illumination system, detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said wirelessly remote controller to the said main system without passing through at least one electrical conductor or fiber-optic cable directly and/or indirectly.

54 The apparatus of claim 1, wherein said the said utility equipment mounting apparatus is for mounting use of surveillance equipment.

55 The apparatus of claim 54, wherein said the said surveillance equipment also includes audio surveillance equipment, video surveillance equipment, picture capturing surveillance equipment and thermal sensing surveillance equipment.

56 The apparatus of claim 1, wherein said the said utility equipment mounting apparatus is for mounting use of scanning equipment for radar frequency signals.

57 The apparatus of claim 1, wherein said the said utility equipment mounting apparatus is for mounting use of infrared thermal scanning equipment

58 The apparatus of claim 1, wherein said the said utility equipment mounting apparatus is for mounting use of infrared sighting equipment

59 The apparatus of claim 1, wherein said the said utility equipment mounting apparatus is for mounting use of antenna.

60 The apparatus of claim 59, wherein said the said antenna is a dish antenna.

61 The apparatus of claim 59, wherein said the said antenna is a satellite antenna.

62 The apparatus of claim 1, wherein said the said utility equipment mounting apparatus is for mounting use of rifle.

63 The apparatus of claim 62, wherein said the said rifle includes single action rifle, semiautomatic rifle and automatic rifle.

64 The apparatus of claim 63, wherein said the said rifle is equipped with a video camera and/or camera with a video signal connected to a monitor with an adjustable cross hair target function.

65 The apparatus of claim 64, wherein said the said adjustable cross hair target function includes cross hair signal, round target signal and signals that represent the target to be struck by the rifle.

66 The apparatus of claim 64, wherein said the said rifle is sighted in with the cross hair on the monitor within the range of the rifle.
Sighted in means the cross hair (target) on the monitor is aligned to the striking target of the rifle at a predetermined distance.
As the video picture is shown on the monitor, the portion of the picture overlapped by the cross hair (target) represents the position the rifle will strike with its ammunition when firing.

67 The apparatus of claim 64, wherein said a method of a remote-control rifle with video camera and/or camera system:
The remote controller includes wirelessly remote controller and non-wirelessly remote-controller.
A non-wirelessly remote controller device generates signals and transmits the signals out by conductor cables or fiber-optic cables.
A wirelessly remote controller device generates signals, which also include radio frequency signals, infrared (IR) signals and emits the said signals wirelessly.
A main system, with pan and tilt function, supports the said rifle with video camera and/or camera system, detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said wirelessly remote controller to the said main system without passing through at least one electrical conductor or fiber-optic cable directly and/or indirectly.

68 The apparatus of claim 1, wherein said the said utility equipment mounting apparatus is for mounting use of telescope.

69 The apparatus of claim 68, wherein said the said telescope is an electronic telescope.

70 The apparatus of claim 1, wherein said the electrical connections of the control cable into the said stator base subassembly are watertight sealed.

71 The apparatus of claim 70, wherein said the said watertight seal is by encapsulation with encapsulation resin.

72 The apparatus of claim 1, wherein said the PCBA charges up the rechargeable battery as life electricity supply is supplied to the said utility equipment mounting apparatus.

73 The apparatus of claim 72, wherein said the life electricity supply includes AC electricity power supply and DC electricity power supply.

74 A method of controlling a utility equipment mounting apparatus remotely by a remote controller:
The said remote controller includes wirelessly remote controller and non-wirelessly remote-controller.
A non-wirelessly remote controller device generates signals and transmits the signals out by conductor cables or fiber-optic cables.
A wirelessly remote controller device generates signals, which also include radio frequency signals, infrared (IR) signals and emits the said signals wirelessly.
An utility equipment mounting apparatus detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said wirelessly remote controller to the said utility equipment mounting apparatus without passing through at least one electrical conductor or fiber-optic cable directly and/or indirectly.
The said utility equipment mounting apparatus also includes battery powered utility equipment mounting apparatus device, solar powered utility equipment mounting apparatus, portable utility equipment mounting apparatus, AC powered utility equipment mounting apparatus and DC powered utility equipment mounting apparatus.
